(19) United States
(12) Patent Application Publication
(10) Pub. No.: US 2022/0314583 A1
(43) Pub. Date: Oct. 6, 2022

(54) FOAMED PVC BOARD AND A METHOD OF MAKING A FOAMED PVC BOARD

(71) Applicant: Inteplast Group Corporation, Livingston, NJ (US)

(72) Inventors: Haur-Horng Yang, Victoria, TX (US); Richard J. Ma, Sugar Land, TX (US)

(21) Appl. No.: 17/703,610

(22) Filed: Mar. 24, 2022

Related U.S. Application Data
(60) Provisional application No. 63/167,917, filed on Mar. 30, 2021.

(51) Int. Cl. B32B 27/06; B32B 5/18; B32B 27/30; B32B 27/20; B32B 7/12; B32B 38/00; B32B 37/12

(52) U.S. Cl. CPC B32B 27/065; B32B 5/18; B32B 27/30; B32B 27/304; B32B 27/20; B32B 7/12; B32B 38/0008; B32B 38/0004; B32B 37/12; B32B 2607/02; B32B 2266/0235; B32B 2250/02; B32B 2250/246; B32B 2305/022

(57) ABSTRACT

In a method of forming a foamed PVC board, a foamed PVC core is formed to have about 1% to about 40% fly ash by weight for adhesion enhancement. Film is laminated to the foamed PVC core with an adhesive between the foamed PVC core and the film. The fly ash in the PVC core enhances the adhesion between the foamed PVC core and the film 120 is increased and resists delamination of the film. A PVC board includes a foamed PVC core, an adhesive, and a film. The foamed PVC core has about 1% to about 40% fly ash by weight for enhanced adhesion between the film and the foamed PVC core. The film is laminated to the foamed PVC core with the adhesive between the foamed PVC core and the film.

### CROSS-REFERENCE TO RELATED APPLICATION

This application claims priority to U.S. Provisional Patent Application Ser. No. 63/167,917, filed Mar. 30, 2021, and entitled A FOAMED PVC BOARD AND A METHOD OF MAKING A FOAMED PVC BOARD, which is hereby incorporated by reference in its entirety.

### FIELD

The present disclosure generally relates to a foamed PVC board and a method of making a foamed PVC board.

### BACKGROUND

Foamed PVC boards are a commonly used form of walling and siding. These PVC boards are commonly laminated with a film that appears to be wood or some other finish.

### SUMMARY

In one aspect, a method of forming a foamed PVC board is disclosed. The method comprises forming a foamed PVC core comprising about 1% to about 40% fly ash by weight for adhesion enhancement and laminating a film to the foamed PVC core with an adhesive between the foamed PVC core and the film. Due to the inclusion of 1% to 40% by weight of fly ash in the PVC core, the adhesion between the foamed PVC core and the film 120 is increased.

In another aspect, a board is disclosed, the board comprising a foamed PVC core, an adhesive, and a film. The foamed PVC core comprises about 1% to about 40% fly ash by weight for enhanced adhesion between the film and the foamed PVC core. The film is laminated to the foamed PVC core with the adhesive between the foamed PVC core and the film.

Other objects and features of the present disclosure will be in part apparent and in part pointed out herein.

### BRIEF DESCRIPTION OF THE DRAWINGS

FIG. 1 is a perspective of a foamed PVC board.

FIG. 2 is a fragmentary perspective of the foamed PVC board.

FIG. 3 is another fragmentary perspective of the foamed PVC board.

FIG. 4 is a color photograph of a foamed PVC board showing delamination of a section of film from a foamed PVC core.

FIG. 5 is an illustration of a foamed PVC core being corona treated.

FIG. 6 is an illustration of a foamed PVC core being heated by heaters.

FIG. 7 is an illustration of a foamed PVC core being laminated by pressure rollers.

FIG. 8 is an illustration of a foamed PVC board waiting to be cut by a saw.

FIG. 9 is an illustration of a foamed PVC board core after having been cut by a saw.

The patent or application file contains at least one drawing executed in color. Copies of this patent or patent application publication with color drawing(s) will be provided by the Office upon request and payment of the necessary fee.

Corresponding reference numbers indicate corresponding parts throughout the drawings.

### DETAILED DESCRIPTION

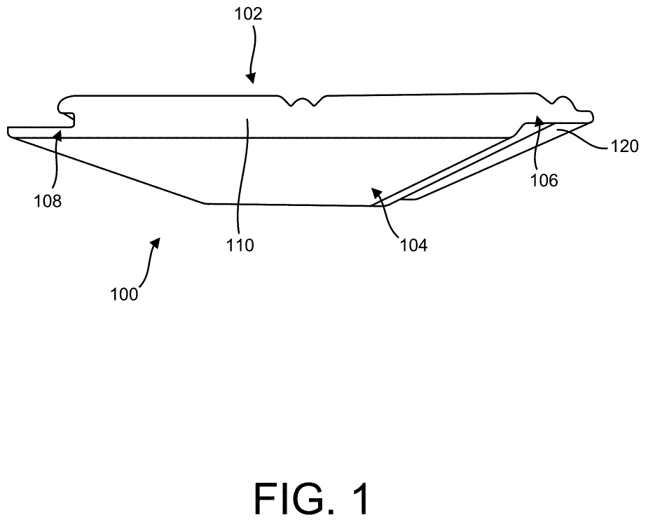

Referring to FIGS. 1-3, a foamed PVC board is generally indicated at reference number 100. In the illustrated embodiment, the board 100 has a beadboard profile suitable for applications in which the appearance of traditional beadboard is desired. Other types of foam boards, however, can also be used or made without departing from the scope of the disclosure, such as a ceiling moulding, door moulding, window moulding, wall moulding, or floor moulding, among others.

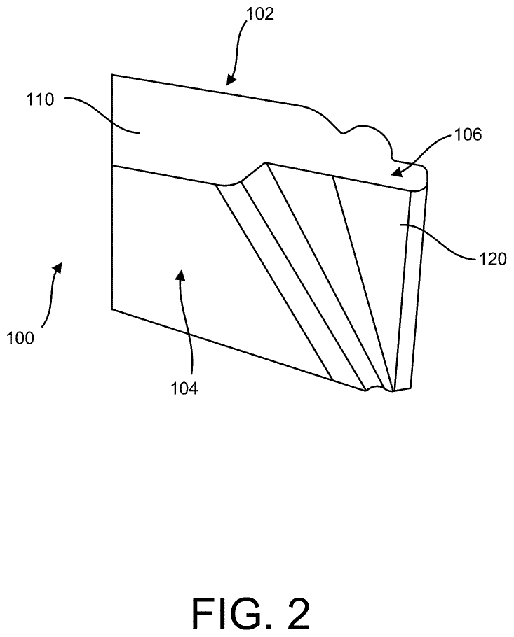

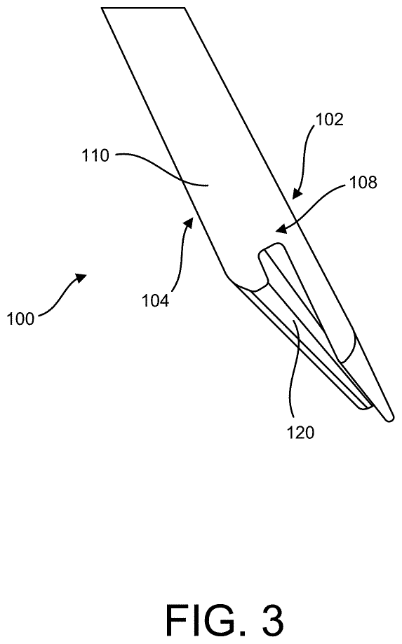

The board 100 includes a front face 102, a back face 104, a right end 106 (FIG. 2), and a left end 108 (FIG. 3). The board 100 is further comprised of a foamed PVC core 110 and a film 120. The front face 102 and a portion of the back face 104 are covered with a film 120. In use, a plurality of boards 100 are coupled together (e.g., by tongue and groove fittings), with the right end 106 of a first board fitting into the left end 108 of the second board. When the plurality of boards 100 are coupled together, the boards are installed on a wall or other backing surface such that the exposed portion of the foamed PVC core 110 on the back face 104 is abutting the backing surface and the film 120 on the front face 102 of the foamed PVC core faces outward. In one or more embodiment, the film 120 has a decorative design, e.g., a woodgrain design.

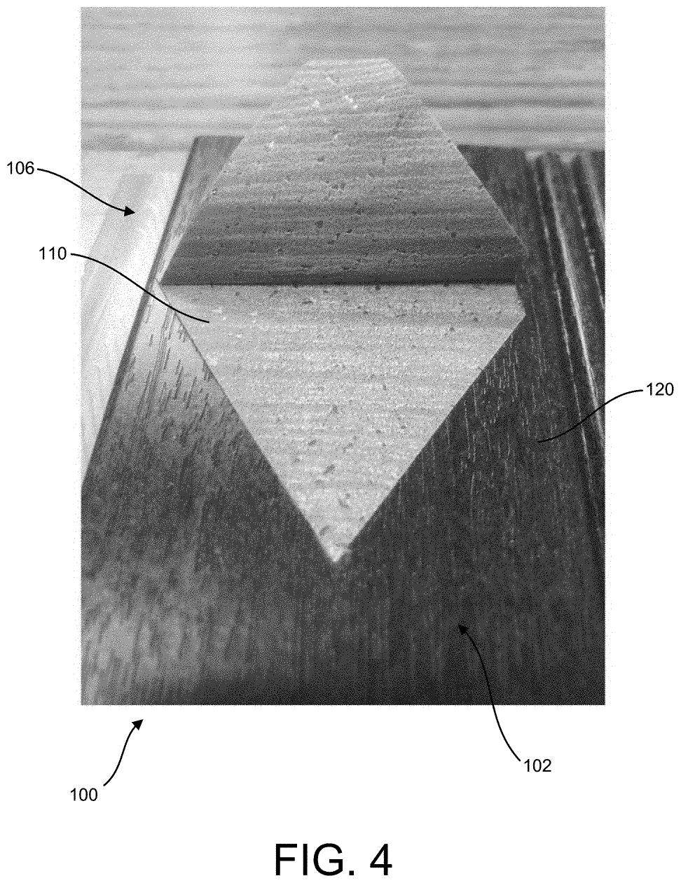

Referring to FIG. 4, the front face 102 of the board 100 is shown with a section of the film 120 peeled off of the foamed PVC core 110. That is, the triangular cutout section has been delaminated from the board. As can be seen by the grey coloring of the underside of the film 120 that has been pulled back, when a portion of the film delaminates from the foamed core 110, it pulls off an upper layer of the foamed core. In other words, the inventors have recognized that, with foamed boards of the type disclosed above, failure does not typically occur at the interface of the film 120 and the foamed PVC core 110, but rather within the foamed PVC core itself. In order to increase the strength of adhesion between the core 110 and the film 120 (broadly, the resistance to delamination of the film), the intra-core strength of the PVC core must therefore be increased.

Typically, in foamed PVC boards, calcium carbonate is used to decrease the cost of the foamed core and improve certain properties like impact strength. The inventors were experimenting with other types of weight reduction fillers, including fly ash. Unexpectedly, the inventors found that adding fly ash to the foamed core at about 1% to about 40% by weight yielded a substantial improvement in adhesion between the foamed core and the film. The inventors have determined that the fly ash improves the intra-core strength and thereby makes it more difficult for the top layer of the foamed core to peel away from the remainder of the core, thus inhibiting delamination. Accordingly, in one or more embodiments, a foamed PVC board in accordance with the present disclosure comprises a foamed PVC core comprising from about 1% to about 40% fly ash by weight (e.g., the foamed PVC core comprises from about 15% to about 40% fly ash by weight, from about 20% to about 40% fly ash by weight, from about 25% to about 40% fly ash by weight, from about 30% to about 40% fly ash by weight, from about 32% to about 38% fly ash by weight, or from about 34% to about 37% fly ash by weight).

In one or more exemplary embodiments, the fly ash comprises Celceram 20A by Boral Resources. Celceram 20A comprises solid calcium aluminosilicate glass spheres. The source for these complex inorganic glass structures is the inorganic material that has coalesced into a sphere during the combustion process of coal in power generation processes. Celceram 20A comprises a mean particle size of 18 microns, a median particle size of 8.5 microns, and a specific gravity of 2.7. To create the foamed PVC core, the fly ash is added into a mixer along with the PVC resin to blend the components together. The blend is introduced to an extruder with the foaming agent. The foaming agent then allows the extruded pellets to expand to fully occupy the product profile.

In accordance with one aspect of the present disclosure, a foamed PVC board 100 is provided comprising a foamed PVC core 110 including fly ash at about 1% to about 40% by weight. A layer of adhesive (e.g., urethane or polyurethane adhesive) is applied along a major surface of the foamed PVC core, and a film 120 (e.g., a vinyl film) is adhered to the major surface by the adhesive. By utilizing fly ash when forming the foamed PVC core 110, the intracore strength is increased. This results in a stronger adhesion to the film 120, as the amount of force needed to peel a portion of the foamed PVC core 110 away from the rest of the foamed PVC core is increased. Thus, the inclusion of fly ash into the manufacturing process for materials such as boards 100 is beneficial to the user of the board.

An exemplary method of making the foamed PVC board 100 described above will now be briefly described. The method comprises a first step of forming a foamed PVC core 110 by including fly ash in a foamed PVC extrusion at from about 1% to about 40% by weight (e.g., by including fly as in a foamed PVC extrusion at from about 15% to about 40% fly ash by weight, from about 20% to about 40% fly ash by weight, from about 25% to about 40% fly ash by weight, from about 30% to about 40% fly ash by weight, from about 32% to about 38% fly ash by weight, or from about 34% to about 37% fly ash by weight). In certain embodiments, the step of forming the foamed PVC core 110 can also comprise including calcium carbonate (greater than 0% calcium carbonate by weight) in the foamed PVC extrusion. In certain embodiments more fly ash is used than calcium carbonate by weight. In other embodiments, the about same amount of fly ash and calcium carbonate are used by weight. In still other embodiments, more calcium carbonate is used than fly ash by weight.

The method further comprises laminating a film 120 to the foamed PVC core 110 with an adhesive between the foamed PVC core and the film. In one embodiment of the method, the film 120 comprises a vinyl film and the adhesive between the foamed PVC core 110 and the film is a polyurethane adhesive. Due to the inclusion of 1% to 40% by weight of fly ash in the PVC core 110, the adhesion between the foamed PVC core and the film 120 is increased.

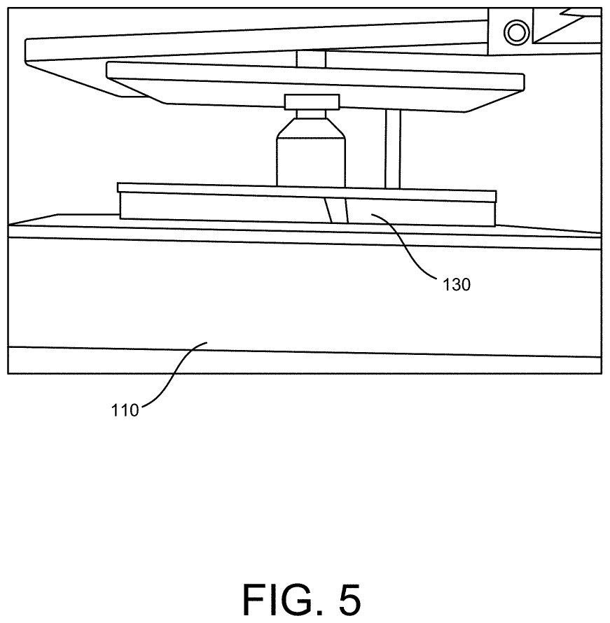

Referring to FIG. 5, the method may further comprise a step of corona treating the foamed PVC core 110 using a high energy voltage to create plasma 130 after the foamed PVC core is extruded and before the film is laminated to the core.

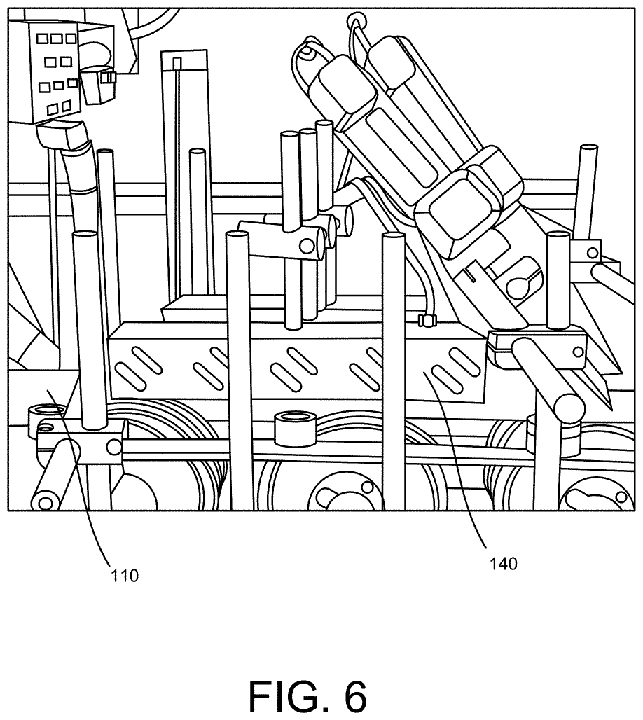

Referring to FIG. 6, the method may further comprise heating the foamed PVC core 110 with heaters 140 to maintain the foamed PVC core's temperature after corona treating and before laminating.

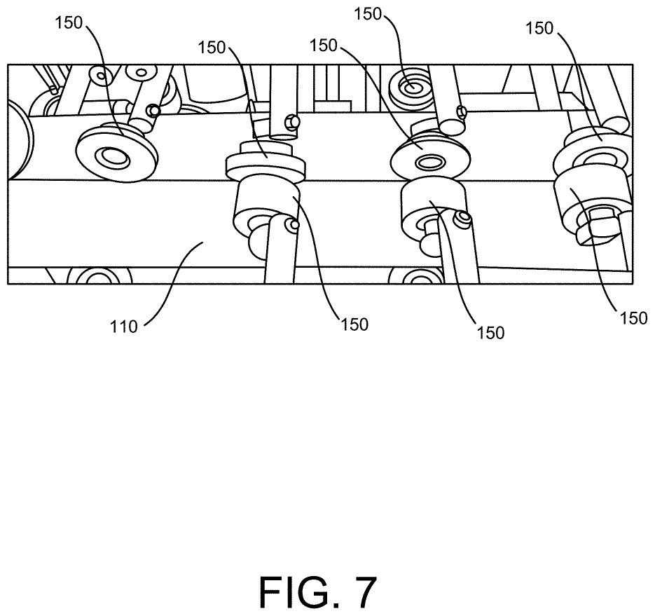

Referring to FIG. 7, the method may further comprise using pressure rollers 150 to wrap the film 120 around a profile contour of the foamed PVC core 110 in the laminating step.

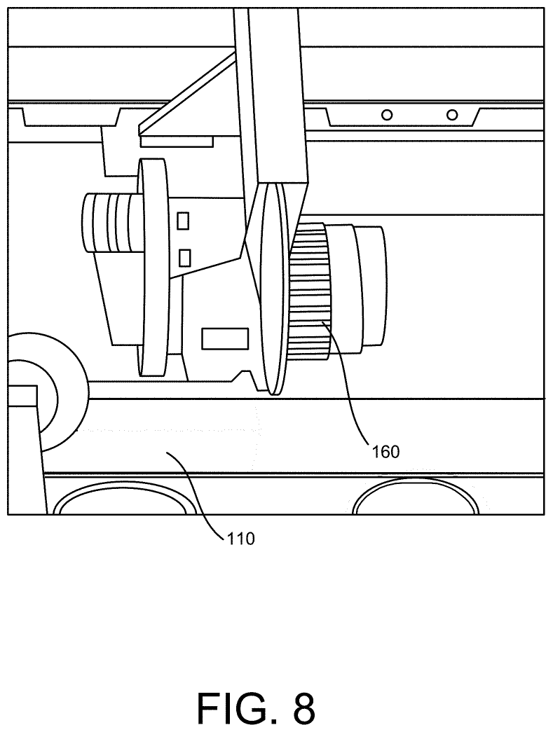

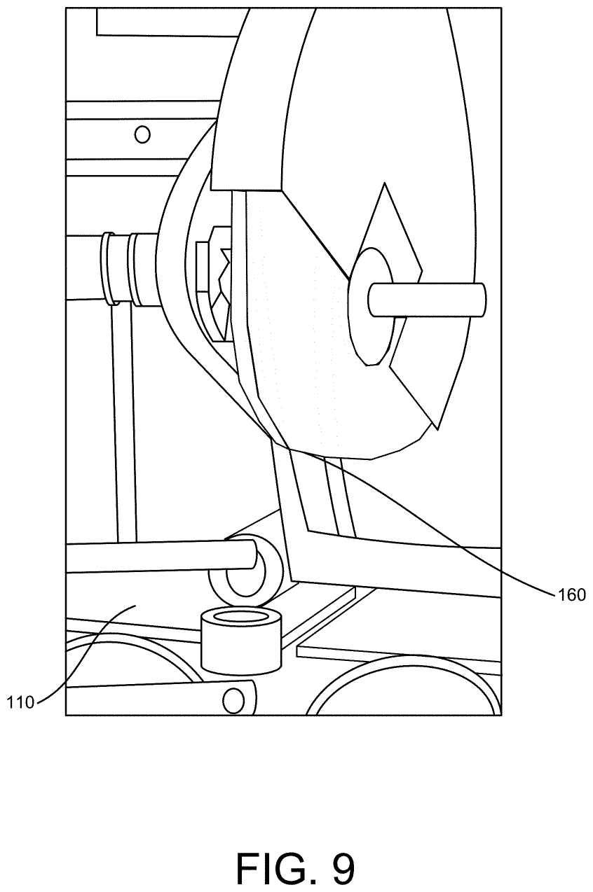

Referring to FIG. 8-9, the method may further comprise cutting the foamed PVC core 110 to its final board length with an in-line automatic saw 160 such that no film 120 overhangs the end of the PVC core.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

What we claim:

1. A method of forming a foamed PVC board, the method comprising:
forming a foamed PVC core comprising about 1% to about 40% fly ash by weight for adhesion enhancement;
laminating a film to the foamed PVC core with an adhesive between the foamed PVC core and the film, wherein the fly ash in the foamed PVC core enhances adhesion between the foamed PVC core and the film.

2. A method as set forth in claim 1, the method further comprising corona treating the formed PVC core using high energy voltage to create plasma after the forming step and before the laminating step.

3. A method as set forth in claim 2, the method further comprising heating the PVC core to maintain the PVC core's temperature after the treating step and before the laminating step.

4. A method as set forth in claim 3, wherein the laminating step further comprises wrapping the film around a profile contour of the PVC core using rollers.

5. A method as set forth in claim 4, the method further comprising cutting the PVC core to a board length with an in-line automatic saw.

6. A method as set forth in claim 1, wherein the adhesive is a polyurethane adhesive.

7. A method as set forth in claim 1, wherein the film is a vinyl film.

8. A method as set forth in claim 1, wherein the foamed PVC core further comprises calcium carbonate.

9. A board, the board comprising:
a foamed PVC core, the foamed PVC core comprising about 1% to about 40% fly ash by weight;
a film; and
an adhesive laminating the film to the foamed PVC core, wherein the fly ash in the foamed PVC core enhances adhesion between the foamed PVC core and the film.

10. A board as set forth in claim 9, wherein the adhesive is a polyurethane adhesive.

11. A board as set forth in claim 10, wherein the film is a vinyl film.

12. A board as set forth in claim 11, wherein the film has a decorative design.

13. A board as set forth in claim 9, the foamed PVC core comprising a front face and a back face, wherein the film laminates the front face and a portion of the back face of the board.

14. A board as set forth in claim 13, the foamed PVC core comprising a first longitudinal edge margin and a second longitudinal edge margin, wherein the first longitudinal edge margin comprises a tongue fitting and the second longitudinal edge margin comprises a groove fitting.
